(19) United States
(12) Patent Application Publication
(10) Pub. No.: US 2005/0001428 A1
(43) Pub. Date: Jan. 6, 2005

(54) Anchor ring

(76) Inventor: Anton Scherrer, Gams (CH)

Correspondence Address: Matthew B Dernier;Kaplan & Gilman, 900 Route 9 North, Woodbridge, NJ, 07095, US

(21) Appl. No.: 10/491,975

(22) PCT Filed: Oct. 8, 2002
(86) PCT No.: PCT/IB02/04114

(30) Foreign Application Priority Data
Oct. 11, 2001 (CH) 1872/01

(51) Int. Cl. F16L 21/02

(52) U.S. Cl. 285/340; 285/420

(57) ABSTRACT

A clamping ring for pipe couplings, in particular for the axial tension-proof connection of smooth-ended pipes is supported on a housing and on the pipe to be connected, where the clamping ring has teeth which can be caused to engage the pipe, the total number of teeth being divided into repeating groups of teeth, at least one group having at least two teeth differing from one another.

### BACKGROUND

The invention relates to a clamping ring for pipe couplings, in particular for the axially tension-proof connection of smooth-ended, metallic pipes, the pipe couplings having a housing which can be clamped around the pipes to be connected and having at least one sealing element preferably consisting of an elastomer and, in the clamped state of the pipe coupling, at least one clamping ring being supported axially and/or radially on the one hand on the housing and on the other hand on one pipe end, the clamping ring having on its inside teeth which can be made to engage the pipe.

The penetration of the teeth into the pipe wall results in an interlocking connection which permits secure clamping of the pipes to be connected in the pipe coupling. In the pipes used today in pipeline construction, different pipe materials and pipe wall thicknesses are used depending on the application. For example, in lightweight construction for aircraft or other vehicles, aluminium alloys and other light metals are used, whereas, for example, very hard titanium alloys are used in the case of higher requirements, also regarding corrosion. Particularly in the case of such pipes of titanium alloys or chromium nickel steels, engagement of the clamping rings known to date is problematic in some cases.

EP 211158 A1 discloses a pipe coupling whose clamping rings have a concave, in particular V-shaped, profile on their end face on the engaging side. The individual teeth are preferably produced by punching. The mode of action of this V-shaped profile consists in the fact that one edge of the end face forms a cutting edge which penetrates into the pipe surface on clamping, while the second edge forms a type of depth stop which limits the penetration of the cutting edge into the pipe surface.

EP 940618 A1 discloses a further pipe coupling whose clamping rings have an asymmetric profile. The asymmetric profile results in the formation of an acute wedge angle which is intended to improve the penetration of the clamping ring into the pipe surface. However, in contrast to the subject of EP 211158 A1, the penetration of the clamping ring into the pipe surface is not limited.

EP 931966 A1 starts from a prior art according to EP 940618 A1, an indentation which is intended to lead to an improvement in the material or the cutting geometry being made laterally in all teeth.

Common to all three EP-A1 documents mentioned is that all teeth over the entire circumference of the clamping ring are identically formed.

Particularly for extreme materials, i.e. particularly soft or particularly hard materials, problems may arise in the case of the known clamping rings in that the clamping ring penetrates either too strongly or not at all into the pipe surface.

### SUMMARY OF THE INVENTION

In accordance with one or more aspects of the invention, a clamping ring is provided for pipe couplings which permits optimal adaptation to the respective pipe material without substantial additional effort.

According to the invention, this is achieved if the total number of teeth is divided into repeating groups of teeth, at least one group having at least two teeth differing from one another, or if at least two groups of teeth which differ from one another are present.

As a result of the different formation of teeth, these engage the pipe material completely, only partly or not at all. Thus, for example for hard materials, the number of teeth engaging the pipe can be reduced compared with the prior art to date. This leads to higher loads on the engaging teeth, both on the tooth and on the pipe material, so that these teeth can better penetrate in the case of hard pipe surfaces and do not slip on the pipe surface.

In an expedient embodiment, at least one group consists of X teeth, the quantity X being between 2 and 10, between 3 and 6 or between 4 and 5. Such groups of teeth may be formed, for example, by means of a punching tool, in which a plurality of teeth are simultaneously punched out of the profiled strip material. The number of teeth per group may also differ in the case of different coupling sizes.

In an advantageous solution, the groups of teeth consist of a number n of A teeth and a number m of B teeth, the clamping edge being slightly recessed in the radial and/or axial direction in the case of the B teeth relative to the A teeth. The A teeth are therefore those which first engage the pipe wall on clamping the pipe coupling. The B teeth recessed relative to the A teeth may engage the pipe surface later or not at all. These B teeth may also be blunt and/or perform the function of a stop limiting the depth of penetration. The sum n+m gives the quantity X of the total number of teeth per group.

The A teeth expediently have a cutting edge on their end face. This cutting edge may run in the circumferential direction of the pipe or, as disclosed, for example, in EP-A1-211158, may be at least partly angled. The first variant results in a linear engagement of the clamping ring with the pipe surface. In the second variant, the engagement of the individual teeth tends to be point-like.

In an advantageous embodiment, the cutting edge is asymmetrical. By means of the asymmetrical cutting form, relatively acute wedge angles can be formed and hence the penetration of the teeth in the pipe material can be facilitated.

Particularly in the case of soft pipe materials, the penetration of the teeth should be limited in order to avoid excessive reduction of the pipe wall thickness. It is therefore expedient if the A teeth have a concave, preferably V-shaped profile on their end face.

The number of teeth can in principle be chosen as desired. However, it is advantageous if the number n is at least 1 and if n is preferably less than the number m. Thus, the number of projecting A teeth is in the minority compared with the B teeth recessed in the axial and/or radial direction. This means that the clamping via a reduced number of teeth is distributed over the circumference.

In an expedient embodiment, A and B teeth are arranged so as to be uniformly distributed within a group or over the entire circumference. Thus, the clamping forces are also uniformly distributed over the circumference or within a group.

In a further advantageous embodiment, the A teeth and the B teeth are arranged so as to be asymmetrically distributed within a group or over the entire circumference. However, in the asymmetrical arrangement, for example, identically formed teeth may be located adjacent to one another and the load thus distributed over a plurality of teeth.

It is expedient if the B teeth are compressed by a material-forming process or are processed by a material-abrading process. The compression of the teeth can be produced, for example, by a cold forming process. As a result, the formed material can, for example, simultaneously serve as a stop limiting the depth of penetration. A suitable material-abrading process is, for example, grinding or milling. Both processes can, for example, also be effected in combination with a punching process.

In an advantageous embodiment, the A teeth are stretched by a forming process or are formed by material application. The stretching of the teeth can be effected, for example, by cold working in a pressing process. Material application can be carried out, for example, by one or more welding processes.

On clamping of the pipe coupling, the clamping ring is reduced in circumference and hence its internal diameter is reduced. The teeth slide over the circumference of the pipe surface. In order to permit this movement, it is advantageous if the lateral flanks of the teeth are bevelled. This avoids the formation of sharp corners which can hook into the pipe surface on clamping of the pipe coupling, making the equilibration over the circumference of the clamping ring difficult or impossible.

### BRIEF DESCRIPTION OF THE DRAWINGS

The invention is to be explained in more detail below with reference to the drawings representing them by way of example. The list of reference numerals and FIG. 1 to FIG. 12, together with the subjects described or protected in the Claims, are an integral part of the disclosure of this Application.

The figures are described in relation to one another and as a whole. Identical reference numerals denote identical components, and reference numerals with different indices indicate components having the same function.

FIG. 1 shows a pipe coupling having a clamping ring according to the invention, partly in longitudinal section;

FIG. 2 shows an end view of the pipe coupling shown in FIG. 1;

FIG. 3 shows a first embodiment of the clamping ring according to the invention;

FIG. 4 shows a variant of the clamping ring shown in FIG. 3;

FIG. 5 shows a variant of the clamping ring shown;

FIG. 5 shows a variant of the clamping ring;

FIG. 6 shows a further variant of the clamping ring;

FIG. 7 shows a section of a variant of the pipe coupling shown in FIG. 1;

FIG. 8 shows a further section through the pipe coupling shown in FIG. 7;

FIG. 9 shows a further section of a variant of the pipe coupling shown in FIG. 1;

FIG. 10 shows a further section through the pipe coupling shown in FIG. 9;

FIG. 11 shows the section of a clamping ring according to the invention, as a view, and

FIG. 12 shows a variant of the clamping ring shown in FIG. 11.

### DETAILED DESCRIPTION OF THE PREFERRED EMBODIMENTS

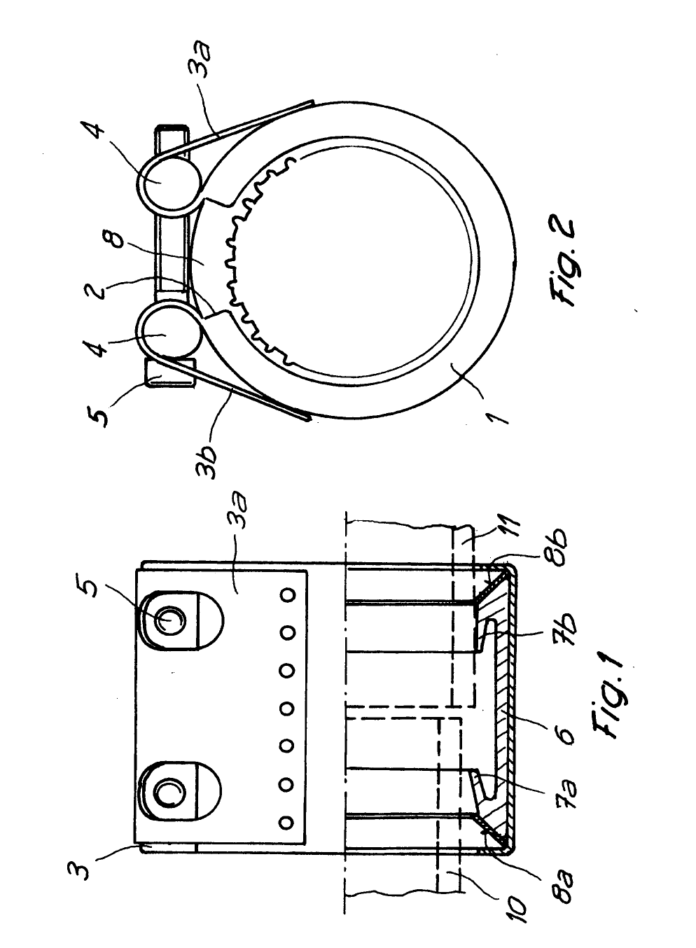

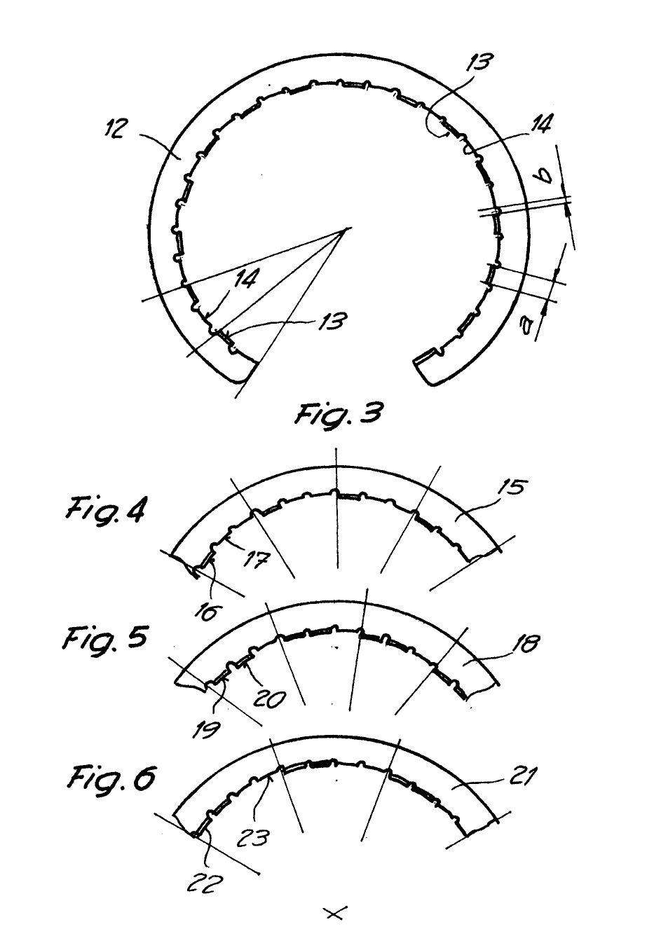

The pipe coupling shown in FIGS. 1 and 2 has a substantially cylindrical housing 1 provided with a longitudinal slot 2, the free ends of the housing 1 being in the form of bent-over straps 3a, 3b. Cylindrical locking pins 4 are arranged in the straps 3a, 3b. The housing 1 can be radially clamped by means of locking bolts 5 which pass through the locking pins 4, it being possible for the longitudinal slot 2 to become narrower. A sealing sleeve 6 preferably consisting of an elastomer and intended for sealing the pipes to be connected is arranged in the housing 1. The sealing sleeve 6 has elastically deformable sealing lips 7a, 7b for this purpose. Present at both ends of the sealing sleeve 6 are clamping rings 8, which are preferably installed at about 45° to the longitudinal axis of the pipe coupling and are supported on the housing 1 in the corner of the side walls of the housing 1 which are directed radially inwards.

As shown in particular in FIG. 2, the clamping rings 8 are provided with teeth 9a, 9b on their free end face. The teeth 9a, 9b are differently formed, the teeth 9a projecting radially inwards beyond the teeth 9b. FIG. 1 shows two pipes 10, 11 to be connected to one another. In the region of the pipe, the pipe coupling is shown in the unclamped state. The sealing lip 7a and the clamping ring 8a do not as yet touch the surface of the pipe 10. In the clamped state of the pipe coupling, shown in the right half, the sealing lip 7b has been placed so as to provide a seal against the surface of the pipe 11, and the teeth 9a of the clamping ring 8b have partly penetrated into the surface of the pipe 11.

FIG. 3 to FIG. 6 show different embodiments of clamping rings.

The clamping ring 12 shown in FIG. 3 has, on its inside, groups of in each case two differently formed teeth. The teeth 13 designated as A teeth project radially inwards beyond the teeth 14 designated as B teeth. In the clamping ring 12, the A teeth 13 and the B teeth 14 are arranged alternately side by side. In other words, the clamping ring 12 has approximately the same number of A teeth 13 and B teeth. In FIG. 3, the tooth width is denoted by “a” and the width of the gaps present between the individual teeth is denoted by “b”.

Assuming that, in the clamped state of the pipe coupling, the clamping ring 12 extends over the entire circumference, the general formula for the bearing circumferential fraction CF is applicable:

$$CF [ \% ] = ( \frac{n}{n + m} ) \cdot ( \frac{a}{a + b} ) \cdot 100 \%$$

Since the number n of A teeth and the number m of B teeth are each equal to 1 in the example of the clamping ring 12 shown in FIG. 3, the bearing circumferential fraction (CF) is therefore:

$$( \frac{1}{1 + 1} ) ( \frac{a}{a + b} ) = \frac{1}{2} ( \frac{a}{a + b} )$$

i.e. the bearing circumferential fraction in this example is only half that of conventional clamping rings having teeth formed uniformly over the entire circumference.

In the case of the clamping ring 15 shown in FIG. 4, a repeating group consists in each case of one A tooth 16 and two B teeth 17 recessed relative to said A tooth. Over the entire circumference, the clamping ring 15 thus has one third A teeth 16 and two thirds B teeth. The bearing circumferential fraction is reduced to one third of that of conventional clamping rings. Such clamping rings 15 are preferably used for relatively hard pipe materials.

The clamping rings 18 and 21 shown in FIGS. 5 and 6 differ from the embodiments according to FIGS. 3 and 4 through the proportions of A teeth 19 and 22 and B teeth 20 and 23.

In the case of the clamping ring shown in FIG. 5, the bearing circumferential fraction CF is:

$$( \frac{2}{2 + 1} ) ( \frac{a}{a + b} ) = \frac{2}{3} ( \frac{a}{a + b} ) ,$$

i.e. the bearing circumferential fraction in this example is ⅔ of that of conventional clamping rings having teeth formed uniformly over the entire circumference.

In the case of the clamping ring 21 shown in FIG. 6, the bearing fraction is, considered purely mathematically, equal to that in the case of the clamping ring 12 in FIG. 3. However, the distribution differs in that two A teeth 22 and two B teeth 23 are always arranged side by side. This can result in more advantageous engagement conditions for certain pipe materials.

Common to these clamping rings is the fact that they have groups repeating over the circumference and comprising differently formed teeth. However, it is also possible for a plurality of different groups of teeth to be arranged so as to be distributed over the circumference. The bearing circumferential fraction can thus be reduced stepwise or digitally and adapted to the respective pipe material through the choice of the number of A teeth and B teeth per group.

Those sections of a pipe coupling which are shown in FIGS. 7 and 8 have a clamping ring 24 clamped between the housing 1 and the pipe 10. The clamping ring 24 has a concave, approximately V-shaped profile on its end face and is provided with sharp A teeth 25 and B teeth 26 recessed, for example, by cold forming. The B teeth 26 can serve as a stop limiting the penetration of the A teeth 25 into the pipe surface of the pipe 10.

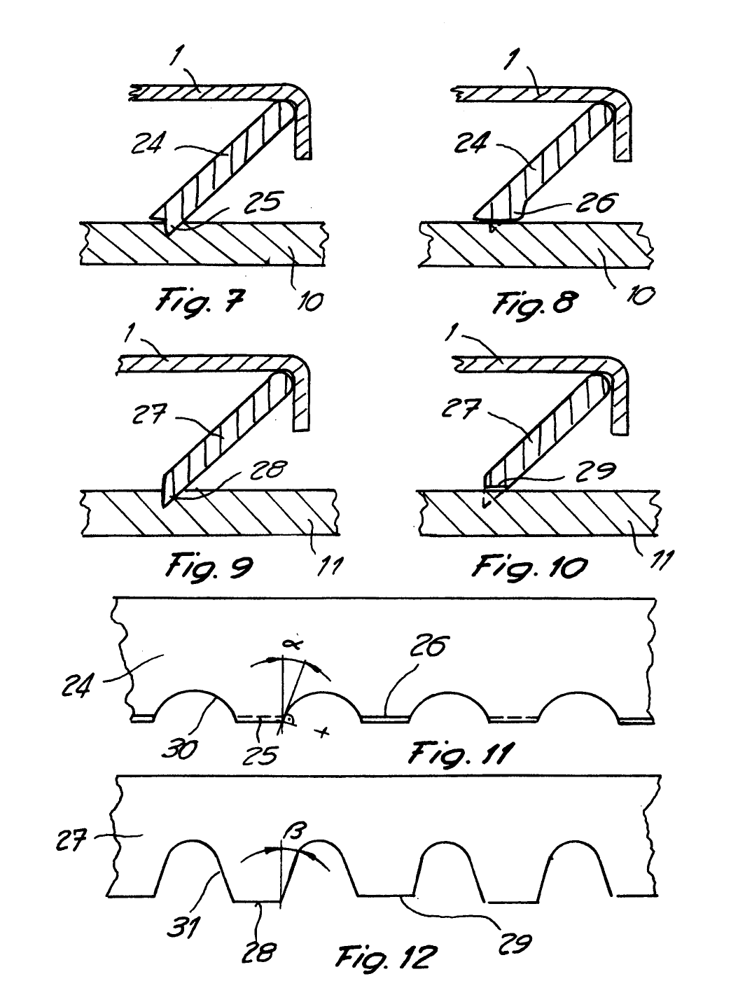

The embodiment shown in FIGS. 9 and 10 differs from the embodiment shown in FIGS. 7 and 8 in the cross-section of the clamping ring 27. The clamping ring 27 has an asymmetrical profile. Blade-like A teeth 28 are formed thereby. The B teeth 29 recessed relative to the A teeth 28 can be produced, for example, by a grinding process. The B teeth 29 can likewise limit the penetration of the A teeth 28 into the surface of the pipe 11.

FIGS. 11 and 12 show the unshaped, strip-like profile of clamping rings 24 and 27, the A teeth 25 and 28 and the B teeth 26 and 29 being produced by recesses 30 and 31. The recesses 31 and 32 are formed in such a way that side walls make acute angles a and B. This prevents the corners of the recesses 31 and 32 from hanging in or hooking in at the pipe surface, when the pipe coupling is clamped, with the result that equilibration of the clamping ring over the entire pipe circumference is hindered or rendered impossible.

List of Reference Numerals

1 Housing
2 Longitudinal slot
3a, b Strap
4 Locking pin
5 Locking bolt
6 Sealing sleeve
7a, b Sealing lip
8a, b Clamping ring
9a, b Teeth
10 Pipe
11 Pipe
12 Clamping ring
13 A tooth
14 B tooth
15 Clamping ring
16 A tooth
17 B tooth
18 Clamping ring
19 A tooth
20 B tooth
21 Clamping ring
22 A tooth
23 B tooth
24 Clamping ring
25 A tooth
26 B tooth
27 Clamping ring
28 A tooth
29 B tooth
30 Recess
31 Recess

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An Apparatus for the axially tension-proof connection of smooth-ended pipes, comprising:
a housing which can be clamped around ends of the pipes and having at least one sealing element preferably consisting of an elastomer; and
at least one clamping ring supported axially and/or radially on the housing and on one pipe end, the clamping ring having on its inside teeth which can be made to engage the pipe,
wherein at least one of (i) a total number of the teeth is divided into repeating groups of teeth, at least one group having at least two teeth differing from one another, and (ii) at least two groups of teeth exist which differ from one another.

2. The apparatus according to claim 1, wherein at least one group of teeth includes X teeth, the quantity X being between at least one of: two and ten, three and six, and four and five.

3. The apparatus according to claim 1, wherein the groups of teeth include a number n of A teeth and a number m of B teeth, and one of the A teeth and the B teeth include a clamping edge being recessed in the radial and/or axial direction in the case of the B teeth relative to the A teeth.

4. The apparatus according to claim 3, wherein the A teeth have a cutting edge on their end face.

5. The apparatus according to claim 4, wherein the cutting edge is asymmetrically formed.

6. The apparatus according to claim 3, wherein the A teeth have a concave, preferably V-shaped profile on their end face.

7. The apparatus according to claim 3, wherein at least one of: (i) the number n is at least 1, and (ii) n is less than the number m.

8. The apparatus according to claim 3, wherein the A teeth and the B teeth are arranged so as to be uniformly distributed within a group or over a circumference inside the clamping ring.

9. The apparatus according to claim 3, wherein the A teeth and the B teeth are arranged so as to be asymmetrically distributed within a group or over a circumference inside the clamping ring.

10. The apparatus according to claim 3, wherein the B teeth are compressed by a forming process or processed by a material-abrading process.

11. The apparatus according to claim 3, wherein the A teeth are stretched by a forming process or formed by material application.

12. The apparatus according to claim 1, wherein lateral flanks of the teeth are bevelled.
